(19) United States
(12) Patent Application Publication
(10) Pub. No.: US 2009/0090399 A1
(43) Pub. Date: Apr. 9, 2009

(54) Fuel Injector Cleaning Apparatus

(76) Inventor: Man Lee-Liao, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/019,954

(22) Filed: Jan. 25, 2008

(30) Foreign Application Priority Data
Oct. 9, 2007 (TW) 96137900

(51) Int. Cl. B08B 13/00

(52) U.S. Cl. 134/169 A

(57) ABSTRACT

A fuel injector cleaning apparatus comprises a platform including a delivery channel, a first orifice adapted for connecting to a source of cleaning fluid and in communication with the delivery channel. An outlet device has one end mounted on the platform and another end for coupling to a fuel injector. A switch device mounted on the outlet device is moveable between a first condition so as to allow the cleaning fluid flow out of the outlet device and a second condition so as to stop the cleaning fluid from flowing out of the outlet device. A pumping device has one end mounted on the platform and another end operably moveable so as to introduce the cleaning fluid into the platform and to the outlet device, whereby the cleaning fluid is released from the outlet device at a predetermined pressure so as to clean the fuel injector thoroughly.

### BACKGROUND OF THE INVENTION

1. Field of the Invention

The present invention relates to a cleaning apparatus, in particular to an apparatus for cleaning fuel injectors of motor vehicles.

2. Description of the Related Art

Over time, carbon deposits becomes deposited in the fuel injector used for injecting fuel to a motor engine and restricts the flow of fuel, thus inferring with engine performance of an automobile. In this regard, the automobile has to go back to the garage for removing such materials in order to restore its original performance.

Taiwan Patent No. M271950 discloses a fuel injector cleaning system including a connection 3 for fuel injector, a switch 4, and a connection 5 for coupling to a source of cleaning fluid. In using the system, the switch 4 is turned to an OFF position so as to prevent fuel flowing from an inlet end 111 to an outlet end 112, and the connection 5 allows the cleaning fluid to flow through the connection 3 for the fuel injector, thus cleaning the fuel injector. However, such system requires the hookup of an air compressor so as to pump the cleaning fluid through the fuel injector. This is not convenient.

The present invention is, therefore, intended to obviate or at least alleviate the problems encountered in the prior art.

### SUMMARY OF THE INVENTION

It is therefore an object of the present invention to provide a fuel injector cleaning apparatus that requires no hookup of an air compressor or the like.

It is another object of the present invention to provide a fuel injector cleaning apparatus that is easy to install and carry.

It is yet another object of the present invention to provide a fuel injector cleaning apparatus that is manually controlled to release cleaning fluid at various predetermined pressure.

Accordingly, the objective is achieved by providing a fuel injector cleaning apparatus comprises a platform including a delivery channel, a first orifice adapted for connecting to a source of cleaning fluid and in communication with the delivery channel. An outlet device has one end mounted on the platform and another end for coupling to a fuel injector. A switch device mounted on the outlet device is moveable between a first condition so as to allow the cleaning fluid flow out of the outlet device and a second condition so as to stop the cleaning fluid from flowing out of the outlet device. A pumping device has one end mounted on the platform and another end operably moveable so as to introduce the cleaning fluid into the platform and to the outlet device, whereby the cleaning fluid is released from the outlet device at a predetermined pressure so as to clean the fuel injector thoroughly.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a fuel injector cleaning apparatus in accordance with the present invention.

FIG. 2 is an exploded perspective view of the apparatus shown in FIG. 1.

FIG. 3 is a cross-sectional view taken along line 3-3 of FIG. 1.

FIG. 4 is a cross-sectional view taken along line 4-4 of FIG. 3.

FIG. 5 is a cross-sectional view taken along line 5-5 of FIG. 3.

FIG. 6 is a cross-sectional view taken along line 6-6 of FIG. 5.

FIG. 7 shows operation of the apparatus shown in FIG. 6, such operation introduces cleaning fluid into the apparatus.

FIG. 8 is similar to FIG. 5, but shows the cleaning fluid generating pressure on the apparatus.

### DETAILED DESCRIPTION OF THE PREFERRED EMBODIMENT

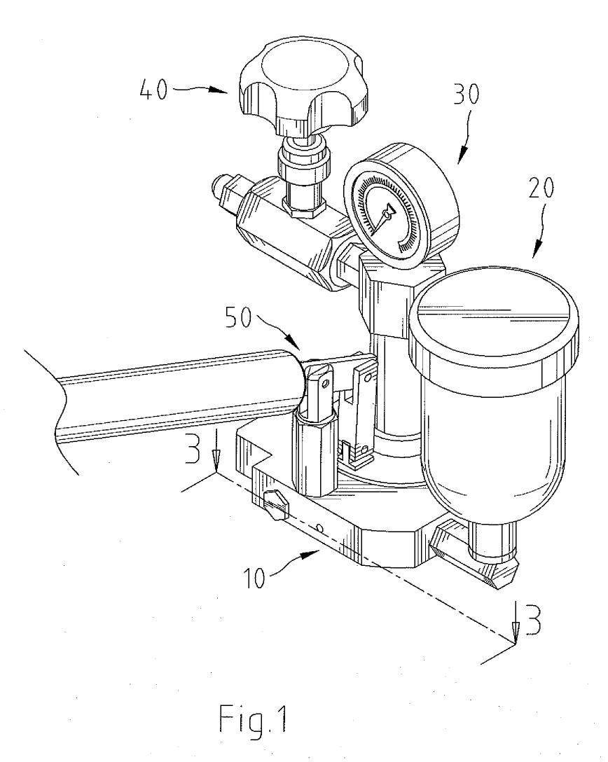

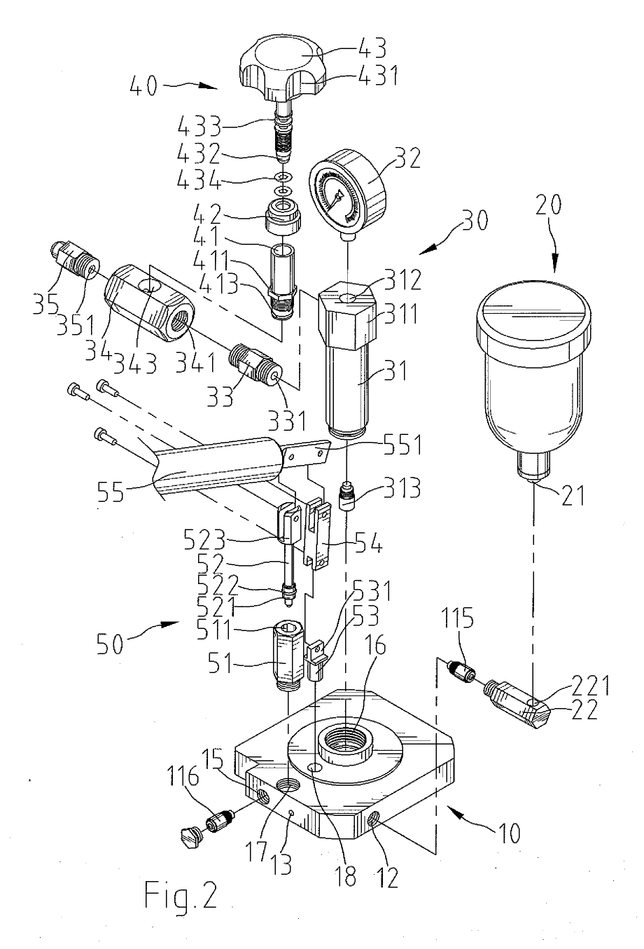

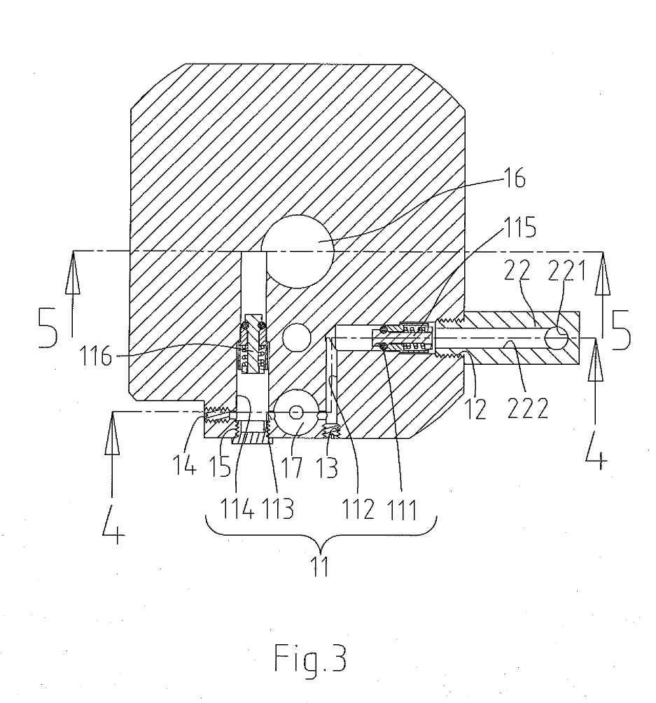

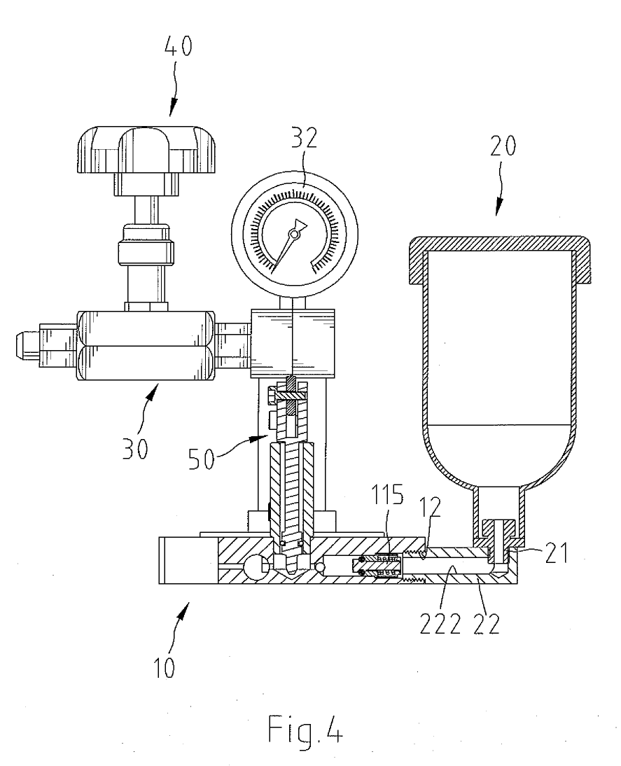

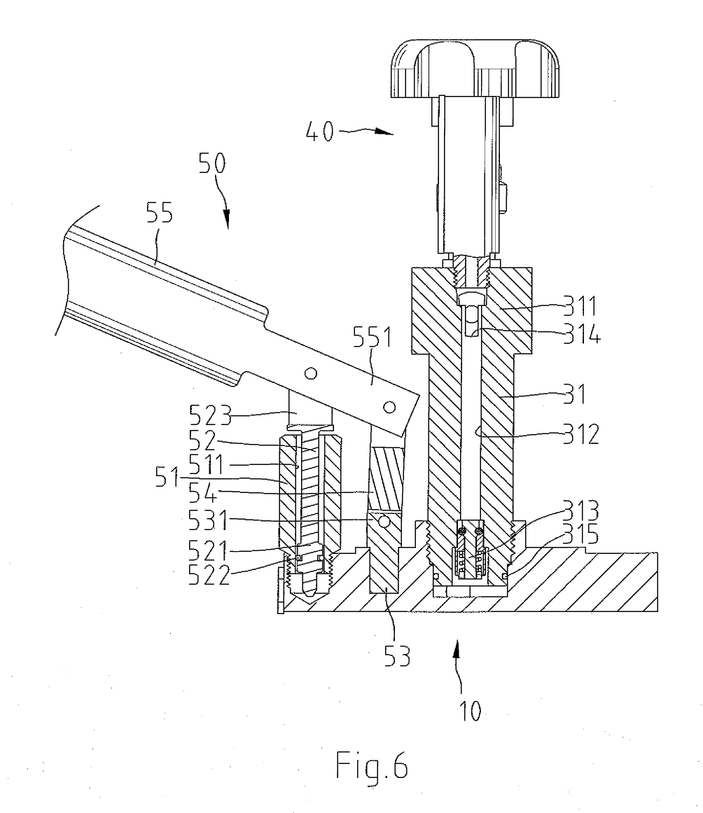

Referring to FIGS. 1 through 6, a fuel injector cleaning apparatus comprises a platform 10 including a delivery channel 11 which extends internally. The delivery channel 11 consists of a first 111, a second 112, a third 113, and a fourth delivery channel 114, and with the delivery channels joined successively in a manner for fluidic communication. An opening of a first orifice 12 is formed on the peripheral edge of the platform 10 and the first orifice 12 extends inwardly to join an end of the first delivery channel 111. The first orifice 12 is adapted to receive a connection of a source of the cleaning fluid for fuel injector. In this embodiment, a connection member 22 for connecting to the source of the cleaning fluid is provided to be threadly engaged with the first orifice 12, and the connection member 22 includes a receiving hole 221 extending radially and a channel 222 intercommunicating the receiving hole 221 and the first delivery channel 11. A reservoir 20 for containing the cleaning fluid has a connecting portion 21 engaged in the receiving hole 221 of the connection member 22. The cleaning fluid in the reservoir 20 is adapted to be introduced into the delivery channel 11 of the platform 10 by operation of a pumping device 50, which will be described in detail below. Furthermore, a check-valve 115 is disposed in the first delivery channel 111 so as to prevent the cleaning fluid from returning back to the reservoir 20.

The platform 10 further includes a second 13, a third 14, and a fourth orifice 15, which has an opening formed on the peripheral edge of the platform 10. In addition, the second orifice 13 extends inwardly to join an end of the second delivery channel 112, the third orifice 14 extends inwardly to join an end of the third delivery channel 113, and the fourth orifice 15 extends inwardly to join an end of the fourth delivery channel 114. Moreover, a check-valve 116 is disposed in the fourth delivery channel 114 so as to prevent the cleaning fluid from returning back to the third delivery channel 11. Furthermore, the platform 10 has a first 16, a second 17, and a third engagement hole 18 which extend internally thereof, and the first engagement hole 16 extends in communication with the terminal end of the delivery channel 11, in this regard, the first engagement hole 16 extends in communication with the terminal end of the fourth delivery channel 114. Also, the second engagement hole 17 extends in communication with the delivery channel 11. In this embodiment, the second engagement hole 17 communicates with the third delivery channel 113.

An outlet device 30 includes a conduit 31 having one end with a seal member 315 disposed thereon for tight engagement in the first engagement hole 16, and a manifold end 311 having a first 312 for receiving a regulator 32 and a second 314 aperture for receiving a joint 34. The conduit 31 defines a passage therein which communicates with the fourth delivery channel 114. In this embodiment, a check-valve 313 is disposed in the passage so as to prevent the cleaning fluid from returning back to the fourth delivery channel 114. A first adapter 33 may be provided for connection between the conduit 31 and the joint 34, and of which formed a through hole 331 communicating with the passage of the conduit 31. A second adapter 35 which has a through hole 351 defined internally is provided for coupling to a fuel injector. It is to be appreciated that the joint 34 may be designed to have a configuration for coupling the fuel injector.

The joint 34 includes a first joining end 341 connects with the first adapter 33 and a second joining end 342 connects with the second adapter 35. The joint 34 further includes a recess 343 extending radially, a first hole 344 extended in communication between the first joining end 341 and the recess 343, and a second hole 345 extended in communication between the second joining end 342 and the recess 343. Accordingly, the first hole 344 is adapted to communicate with the through hole 331 of the first adapter 33, which is received in the first joining end 341 of the joint 34. The second hole 345 is adapted to communicate with the through hole 351 of the second adapter 35, which is received in the second joining end 342 of the joint 34.

A switch device 40 includes a housing 41 having one end with a seal member 413 disposed thereon for tight engagement in the recess 343 of the joint 34. The housing 41 has a first void 412, a second void 414, with the first void 412 having an internal diameter smaller than that of the second void 414. The first void has an opening communicating with the first hole 344 and another opening communicating with the second void 414, while the second void 414 has an opening communicating with the second hole 345. The housing 41 further includes a flange 411 extended radially from the periphery thereof. A cap 42 is mounted to an end of the housing 41. A spindle 43 inserted through the cap 42 is moveably mounted in the housing 41. The spindle 43 includes an operation portion 431 at one end and a blocking portion 432 at an opposite end. The spindle 43 further includes at least one groove 433 with at least one seal member 434 disposed thereon respectively.

The pumping device 50 includes a joint member 51 having one end engaged in the second engagement hole 17. The joint member 51 has a compartment 511 extended internally. A rod 52 received in the joint member 51 includes a first end 521 operably moveable in relation to the compartment 511, a seal member disposed thereon, and a second end 523 for coupling to an operation member 55, which is used for introducing the cleaning fluid into the platform 10 and to the outlet device 30. In this embodiment, the operation member 55 includes a link end 551 for coupling to the second end 523 of the rod 52. An extension 53 extended from the joint member 51 and engaged in the third engagement hole 18 includes an connection end 531. A linkage member 54 has an end coupled to the connection end 531 of the extension 53 and another end coupled to the link end 551.

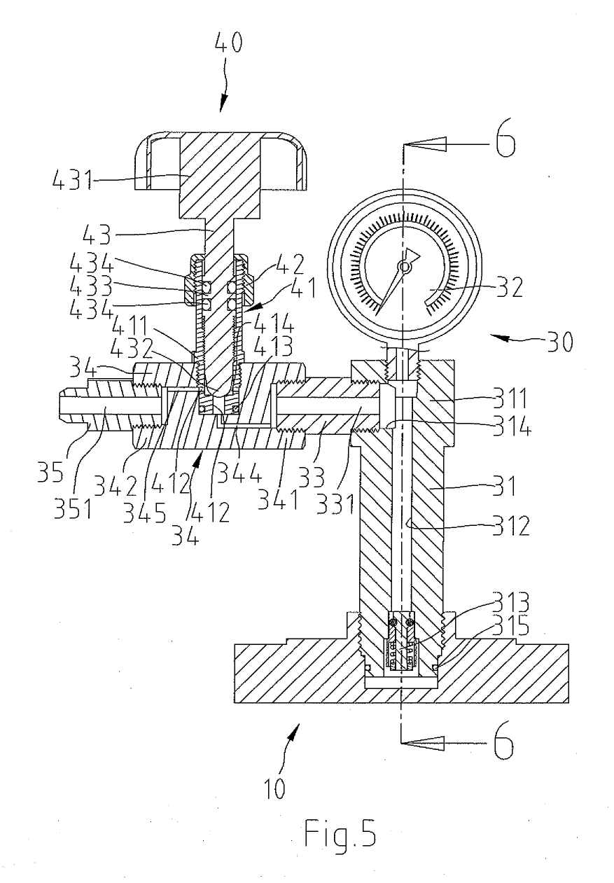

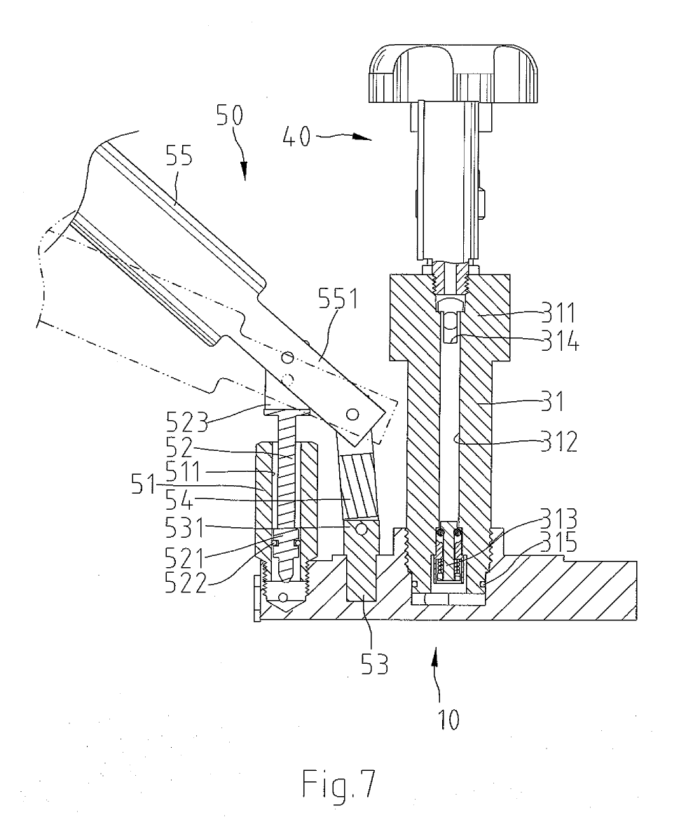

As seen in FIG. 5, in using the cleaning apparatus, the switch device 40 has to be in a first condition, in which the blocking portion 432 blocks fluidic communication between the first 344 and second 345 holes. Referring to FIG. 7, the operation member 55 of the pumping device 50 is operated so as to introduce the cleaning fluid from the reservoir 20 into the delivery channel 11 and to the outlet device 30. Therefore, the cleaning fluid is retained between the check-valve 313 and the blocking portion 432 and the pressure read by the pressure regulator 32 starts to increase due to an increased amount of the cleaning fluid being trapped within the outlet device 30.

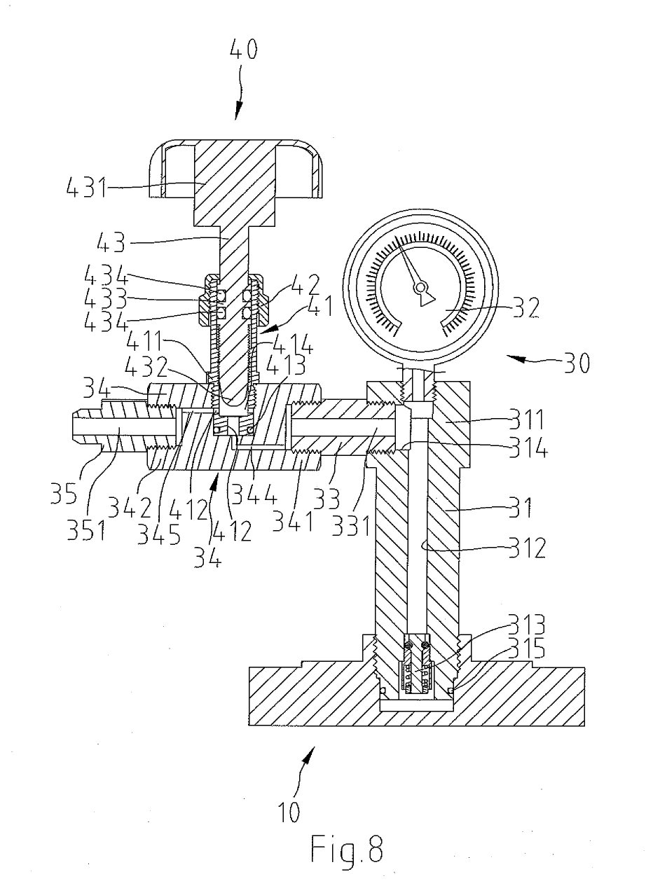

Referring to FIG. 8, when an predetermined pressure is reached, the switch device 40 is then moved to a second condition, in which the blocking portion 432 is moved outward of the recess 343 until the fluidic communication between the first 344 and second 345 holes are allowed. In this case, the cleaning fluid will be released from the outlet device 30 at this predetermined pressure so as to clean the fuel injector, which is coupled to the second adapter 35, thoroughly.

While the specific embodiments have been illustrated and described, numerous modifications come to mind without significantly departing from the spirit of invention and the scope of invention is only limited by the scope of accompanying claims.

What is claimed is:

1. A fuel injector cleaning apparatus comprising:
a platform including a delivery channel, a first orifice adapted for connecting to a source of cleaning fluid and in communication with the delivery channel;
an outlet device having one end mounted on the platform and another end for coupling to a fuel injector;
a switch device mounted on the outlet device being moveable between a first condition so as to allow the cleaning fluid flow out of the outlet device and a second condition so as to stop the cleaning fluid from flowing out of the outlet device; and
a pumping device having one end mounted on the platform and another end operably moveable so as to introduce the cleaning fluid into the platform and to the outlet device, whereby the cleaning fluid is released from the outlet device at a predetermined pressure so as to clean the fuel injector thoroughly.

2. The fuel injector cleaning apparatus as claimed in claim 1 further comprising a reservoir connected to the platform for containing cleaning fluid to be delivered to the platform.

3. The fuel injector cleaning apparatus as claimed in claim 1 wherein the outlet device comprises a conduit having one end coupled to the platform, a joint having one end coupled to another end of the conduit.

4. The fuel injector as claimed in claim 4 further comprising a first adapter interconnecting the joint and the conduit and a second adapter interconnecting the joint and the fuel injector, and wherein the joint comprises a first joining end connecting with the first adapter and a second joining end connecting with the second adapter, the joint further comprises a recess for radially receiving the switch device, a first hole extended in communication between the first joining end and the recess, and a second hole extended in communication between the second joining end and the recess.

5. The fuel injector as claimed in claim 1 wherein the switch device comprises a housing having one end coupled to the outlet device, a spindle moveably mounted in the housing.

6. The fuel injector as claimed in claim 4 wherein the switch device comprises a housing having one end received in the recess, a spindle moveably mounted in the housing and the recess.

7. The fuel injector as claimed in claim 6 wherein the spindle is moveable inward of the recess so as to allow the fluidic communication between the first and second holes and outward of the recess so as to block the fluidic communication between the first and second holes.

8. The fuel injector as claimed in claim 1 wherein the pumping device comprises a joint member having one end mounted on the platform, a rod received in and moving in relation to the joint member, and an operation member mounted to and moving in relation to the rod.

9. The fuel injector as claimed in claim 8 wherein the pumping device comprises an extension connected to the platform, and a linkage member for coupling the extension to the operation member.

10. The fuel injector as claimed in claim 1 wherein the delivery channel comprises at least one check-valve disposed therein.

11. The fuel injector as claimed in claim 1 wherein the outlet device comprises a check-valve disposed therein.

12. The fuel injector as claimed in claim 5 wherein the housing comprises defines a first void and a second void, with the first void having an internal diameter smaller than that of the second void.

13. The fuel injector as claimed in claim 6 wherein the housing comprises defines a first void and a second void, with the first void having an internal diameter than that of the second void.

14. The fuel injector as claimed in claim 1 wherein the outlet device comprises a pressure regulator mounted thereto.

15. The fuel injector as claimed in claim 1 wherein the platform comprises a first engagement hole adapted to receive an end of the outlet device and in communication with the delivery channel, and a second engagement hole adapted to receive an end of the pumping device and in communication with the delivery channel.
